(19) United States
(12) Patent Application Publication
(10) Pub. No.: US 2017/0127774 A1
(43) Pub. Date: May 11, 2017

(54) Survival Rod System

(71) Applicant: Rafik Babakhani, Tujunga, CA (US)

(72) Inventor: Rafik Babakhani, Tujunga, CA (US)

(21) Appl. No.: 15/243,893

(22) Filed: Aug. 22, 2016

Related U.S. Application Data
(60) Provisional application No. 62/208,043, filed on Aug. 21, 2015.

(51) Int. Cl. A45B 9/00; A01K 81/04; A01K 97/06; A45B 3/04; A47G 9/02; A45B 3/16; A45B 3/00; B25D 7/00; B63H 16/04; C02F 1/00; A01M 31/00; A45B 3/14

(52) U.S. Cl. CPC A45B 9/00; A01M 31/00; A01K 81/04; A01K 97/06; A45B 3/04; A45B 3/14; A45B 3/16; A45B 3/00; B25D 7/00; B63H 16/04; C02F 1/002; A47G 9/0223; A45B 2009/002; C02F 2201/008

(57) ABSTRACT

A survival rod system for surviving in the event of an emergency is provided. The survival rod system comprises a plurality of interconnecting tubular rod sections creating an elongated, survival rod having a first end and a second end. Each rod section has a hollowed interior sized, shaped, and adapted for storing one or more implements within each rod section.

### CLAIM OF PRIORITY

This patent application claims priority under 35 USC 119 (e) (1) from U.S. Provisional Patent Application Ser. No. 62/208,043 filed Aug. 21, 2015, of common inventorship herewith entitled, “The Ultimate Survival Rod,” which is incorporated herein by reference as though the same were set forth in its entirety.

### FIELD OF THE INVENTION

The present invention pertains to the field of ambulatory aids, and more specifically to the field of multifunctional walking canes.

### BACKGROUND OF THE INVENTION

For many people, little is more revered than recreation. Whether embarking on a road trip, spending a leisurely day hunting or fishing, cruising the waters on a boat, camping out in the wilderness or hitting biking and hiking trails, many people relish any opportunity to leave behind the constant demands of on the go living to bask in exploration and adventure. With such outings, individuals take the time to compose a meticulous list of needed supplies, ensuring that nothing is forgotten that is essential to experiencing a wonderful time. Sunscreen, bottled water, trail mix and even travel games are just a few of the items deemed necessary for a recreational outing. With their minds essentially on the fun of recreation, many people neglect to consider taking along items that may come in handy during an unexpected turn of events. Should a hunter inadvertently become separated from his friends and find himself lost in the woods, it is likely he will be without a flashlight to allow him to see in the dark, or waterproof matches to build a fire to keep him warm or to signal his distress. Likewise, someone whose car breaks down in a desolate, unfamiliar territory may only have a cellular telephone and be without a blanket or similar means of keeping their body warm until help can arrive.

The prior art has put forth several designs for multifunctional walking canes. Among these are:

U.S. Pat. No. 8,424,548 to Glenn M. Willey describes a combination ambulatory assistance and electrical shock defensive device includes an elongated body of adjustable length and having a hand grip at one end thereof and a foot pad at a generally opposite end thereof. A high voltage power unit is associated with the body and actuated by a trigger mechanism. Conductive contacts extend through the foot pad and are conductively coupled to the high voltage power unit.

US Patent 2005/0211284 to David Dooley describes a trekking staff having a solid shaft portion and a hollow elongated chamber portion provides sufficient strength for allowing a user to dynamically load the trekking staff with a significant portion of the user's bodyweight with a minimal possibility of the shaft portion bending or failing. The hollow elongated chamber portion is detachably coupled to the solid shaft portion, and can include a direction finding device, a compass, a personal water purification system, a personal water collection system, a personal first aid kit, survival equipment, unidirectional or bidirectional communication equipment, a transmitter that transmits a homing signal and a positional information signal. A grip portion has a shape that conforms to a shape of the trekking staff and can include a strand of cord like material. A light emitting device is selectively controlled to emit either a constant light or a flashing light.

U.S. Pat. No. 4,314,575 to Chin-Tui Kuo describes a multipurpose stick or cane comprised of a hollow main body with its one end being closed and its other end being opened. A copper head member is adapted to come in threaded engagement with the fore end of the body, a rod member is adapted to be accommodated in the hollow portion of the body, and a head member is adapted to come in threaded engagement with the rear end of the rod member and to be threadably fixed on a joint of the rear end of the body. This stick or cane is used as a walking stick, a birch rod, a cue or an alpenstock.

None of these prior art references describe the present invention.

### SUMMARY OF THE INVENTION

It is an object of the present invention to provide a portable walking stick that is configured to house a wide variety of implements to be used in the event of an emergency.

The present invention is a survival rod system for surviving in the event of an emergency. The survival rod system comprises a plurality of interconnecting tubular rod sections creating an elongated, survival rod having a first end and a second end. Each rod section has a hollowed interior sized, shaped, and adapted for storing one or more implements within each of the rod sections.

In addition, the present invention is a method for surviving in the event of an emergency. The method comprises providing a plurality of interconnecting hollow tubular rod sections, connecting the tubular rod sections, creating an elongated, survival rod having a first end and a second end, and storing one or more implements within the tubular rod sections.

The present invention further includes a survival rod system for surviving in the event of an emergency. The survival rod system comprises a plurality of interconnecting tubular rod sections with each rod section has threaded male end and a correspondingly threaded female end. The male end of a rod section is releasably, threadably securable to the female end of an adjacent rod section with the connected rod sections creating an elongated, survival rod having a first end and a second end. A tool is pivotally connected nearingly adjacent the first end of the survival rod. A pointed end piece is threadably attached to the second end of the survival rod. Each rod section has a hollowed interior sized, shaped, and adapted for storing one or more implements within each of the rod sections.

### BRIEF DESCRIPTION OF THE DRAWINGS

FIG. 1 is a perspective view illustrating a survival rod system, constructed in accordance with the present invention, showing exterior tools, a rail system for fastening accessories, a telescope, and a flashlight.

FIG. 2 is a sectional plan view illustrating the rail system of the survival rod system, constructed in accordance with the present invention.

FIG. 3 is a perspective view illustrating of the survival rod system constructed in accordance with the present invention, showing a close up view of a threaded connection functionality for connecting different rod parts together.

FIG. 4 is a perspective view illustrating the survival rod system, constructed in accordance with the present invention, showing a close up view of blow darts housed in a rod section.

FIG. 5 is a perspective view illustrating the survival rod system, constructed in accordance with the present invention, showing a close up view of the removable pointed end.

FIG. 6 is a perspective view illustrating the survival rod system, constructed in accordance with the present invention, showing a close up view of a spear blade housed in a rod section.

FIG. 7 is a front sectional view illustrating the survival rod system, constructed in accordance with the present invention, showing a light housed in a rod section.

FIG. 8 is a front sectional view illustrating the survival rod system, constructed in accordance with the present invention, showing a flare gun and spare flares housed in a rod section.

FIG. 9 is a front sectional view illustrating the survival rod system, constructed in accordance with the present invention, showing an Allen wrench housed in a rod section.

FIGS. 10 and 11 are sectional views illustrating a rod section of the survival rod system, constructed in accordance with the present invention, showing an attachment and trigger for mini crossbow for hunting small game.

FIG. 12 is a front sectional view illustrating the survival rod system, constructed in accordance with the present invention, showing a disassembled probe rod housed in a rod section.

FIG. 13 is a front view illustrating a constructed probe rod of the survival rod system of FIG. 12, constructed in accordance with the present invention.

FIG. 14 is a front view illustrating the survival rod system, constructed in accordance with the present invention, showing an anchor in a collapsed position.

FIG. 15 is a front view illustrating the survival rod system of FIG. 14, constructed in accordance with the present invention, showing the anchor in an expanded position.

FIG. 16 is a front view illustrating the survival rod system, constructed in accordance with the present invention, showing a pick axe releasably secured in a useable position.

FIG. 17 is a front view illustrating the survival rod system, constructed in accordance with the present invention, showing the pick axe in a rotated, out of the way position.

FIG. 18 is a front view illustrating the survival rod system, constructed in accordance with the present invention, showing a paddle attached to an end of the survival rod.

FIG. 19 is a front view illustrating the survival rod system, constructed in accordance with the present invention, showing a spear attached to an end of the survival rod for fishing, hunting, and defense.

FIG. 20 is a front view illustrating a carrying case, constructed in accordance with the present invention, securable to a backpack or the like for carrying the survival rod system.

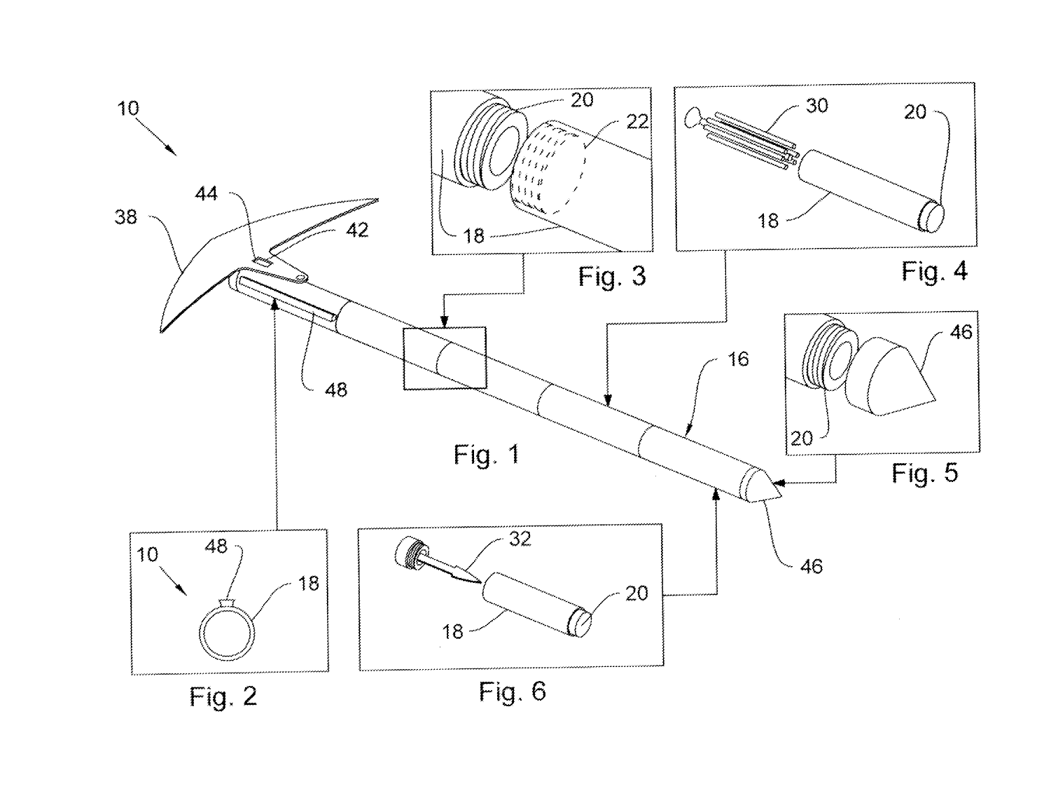

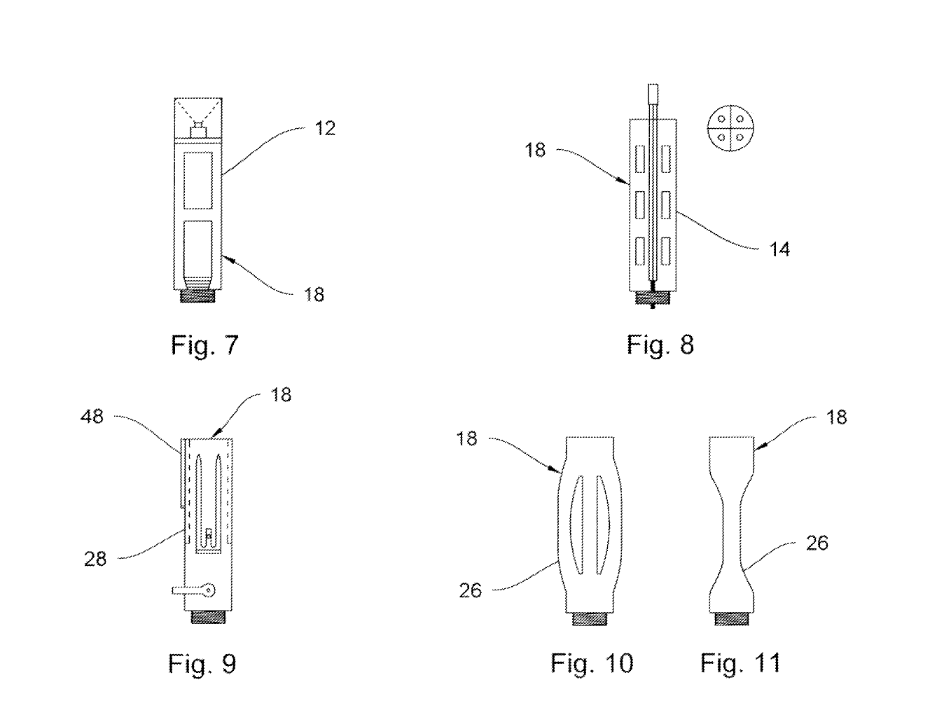

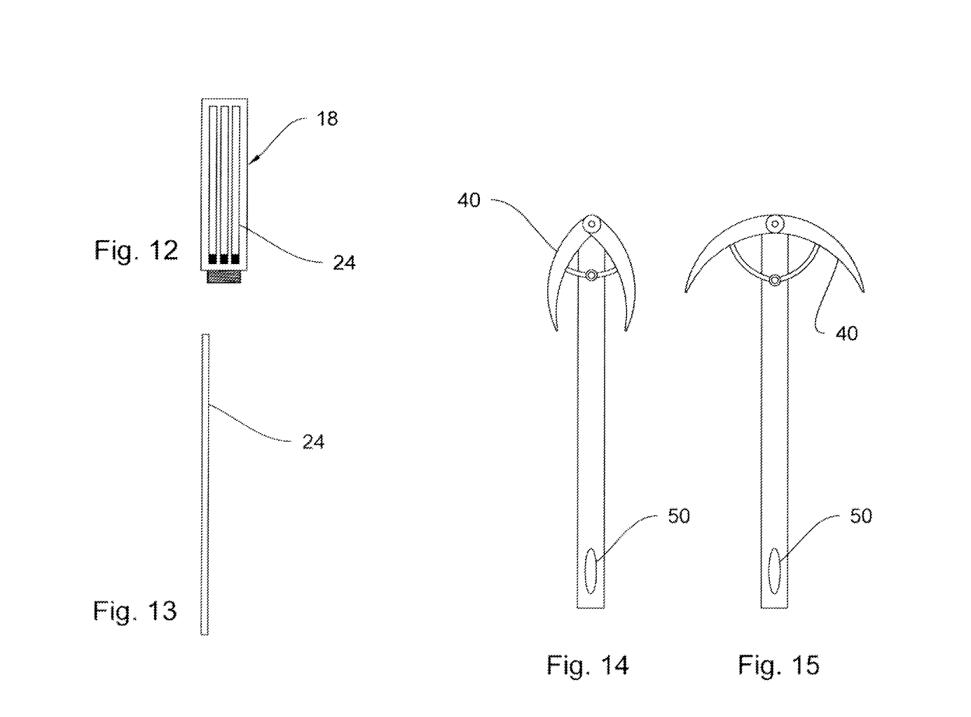

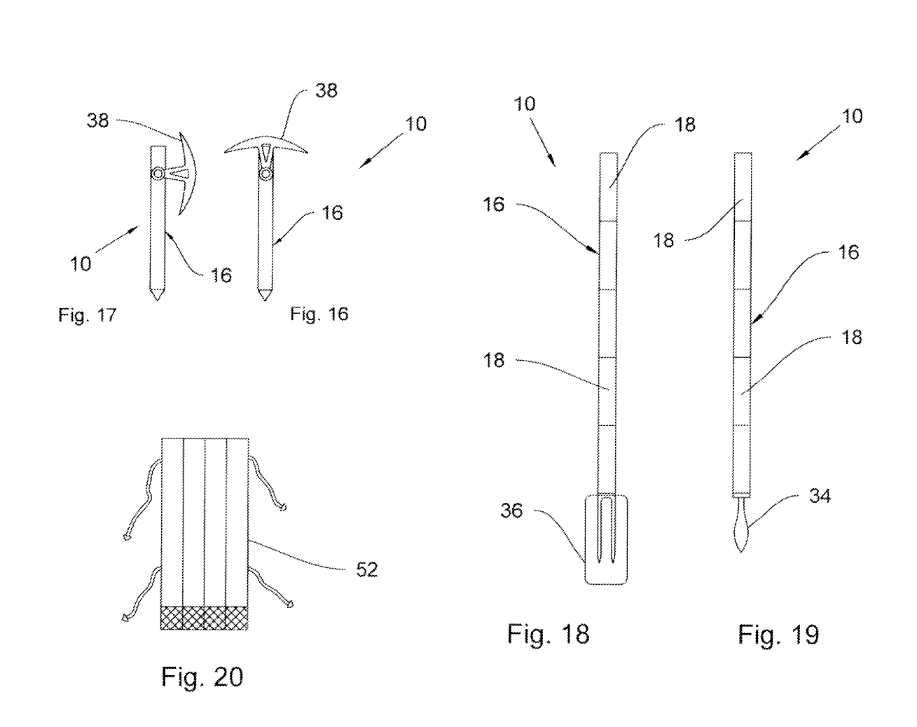

### DETAILED DESCRIPTION OF THE INVENTION

The present invention, hereinafter referred to as the Survival Rod System, indicated generally at 10, is a portable walking stick configured to house a wide variety of items that are useful in an event of an emergency. The Survival Rod System 10 provides users, particularly outdoor enthusiasts, with items they may need if they become lost or injured in a remote location. Filled with staples such as a flashlight 12, flares 14, fishing and hunting equipment, rescue aides, and/or a blanket to help battle the elements, the Survival Rod System 10 is a vital aid in an emergency situation to ease discomfort until rescue help arrives.

The Survival Rod System 10 of the present invention includes an elongated, tubular survival rod 16 having a first end and a second end. Preferably, the survival rod 16 is constructed from a combination of durable and waterproof plastic, titanium, and/or aluminum materials. As understood by those persons skilled in the art, although the survival rod 16 has been described and illustrated as being constructed from a particular material or materials, it is within the scope of the present invention to construct the survival rod 16 from another material or materials.

The survival rod of the Survival Rod System 10 of the present invention includes a plurality of interconnecting rod sections 18. Each rod section 18 has threaded male end 20 and a correspondingly threaded female end 22. The male end 20 of a rod section 18 is releasably, threadably securable to the female end 22 of an adjacent rod section 18 allowing multiple rod sections 18 to be joined in formation of the survival rod 16.

Each rod section 18 of the survival rod 16 of the Survival Rod System 10 of the present invention contains a hollowed interior sized, shaped, and adapted for storing the one or more of many different types of implements. The stored implements include, but are not limited to, a water filter, a flashlight 12, a blanket, two to three days' worth of food rations, flares 14, a probe rod 24, a mini cross bow 26, an Allen wrench 28, a blow gun and darts 30, a blade 32, and/or fishing supplies. Other included implements include, but are not limited to, exterior attachments such as a spear 34 for hunting and fishing, a pickax or rock guide or ice pick, and/or a paddle 36.

The first end of the survival rod 16 of the Survival Rod System 10 of the present invention includes a pick axe tool 38 or anchor 40 pivotally connected nearingly adjacent the first end of the survival rod 16. The pick axe tool 38 or anchor 40 includes a slot 42 for receiving a nub 44 located at the first end of the survival rod 16 for releasably securing the pick axe tool 38 or anchor 40 in place. To rotatably move the pick axe tool 38 or anchor 40, user merely manipulates the pick axe tool 38 or anchor 40 away from the nub allowing the pick axe tool 38 or anchor 40 to swing out of the way.

The second end of the survival rod 16 of the Survival Rod System 10 of the present invention includes a pointed end piece 46 threadably attached to the second end of the survival rod 16. The pointed end 46 is useful for steadying the survival rod 16 while being used as a walking stick or the like.

In addition, the Survival Rod System 10 of the present invention can include a rail system 48 for fastening accessories along the length of the survival rod 16. It should be noted that the rail system 48 can run the entire length of the survival rod 16 or just on select rod sections 18, depending on the needs of the user.

Furthermore, the Survival Rod System 10 of the present invention can include a companion rope eyelet 50 on the second end of the survival rod 16 and straps and carrying case 52 for securement of the survival rod 16 to a person's body or backpack such that the survival rod 16 can be carried as a walking stick or cane when needed.

Use of the Survival Rod System 10 of the present invention is very simple and straightforward. In the event of an emergency, the user retrieves the survival rod 16 of the Survival Rod System 10 and pulls out a needed implement from one of the rod sections 16. A hiker who has lost their way on a hiking trail can appropriate the flares 14 to signal distress. A stranded motorist on a cold dark road can wrap up in the blanket, stand outside his car and use the flashlight 12 to capture the attention of passing motorists. Regardless of the situation, the items stored within the Survival Rod System 10 are readily usable for virtually any snafu.

The Survival Rod System 10 of the present invention provides users with a plethora of much needed assistance should the unexpected occur, all encompassed within a handy walking staff. Whether hunting, mountain biking, camping or simply driving to the next town for a day of shopping, the items stored within the Survival Rod System 10 of the present invention will accommodate a variety of unforeseen circumstances that can occur when enjoying recreational activities. Lightweight and unobtrusive, the present invention is easily stored within a car trunk, a boat caddy, or even tied onto a bicycle seat. As all items within the durably constructed Survival Rod System 10 are nonperishable, the Survival Rod System 10 and its contents will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A survival rod system for surviving in the event of an emergency, the survival rod system comprising:
a plurality of interconnecting tubular rod sections creating an elongated, survival rod having a first end and a second end;
wherein each rod section has a hollowed interior sized, shaped, and adapted for storing one or more implements within each of the rod sections.

2. The survival rod system of claim wherein each rod section has threaded male end and a correspondingly threaded female end, the male end of a rod section being releasably, threadably securable to the female end of an adjacent rod section.

3. The survival rod system of claim 1 wherein the survival rod is constructed from a combination of durable and waterproof plastic, titanium, and/or aluminum materials.

4. The survival rod system of claim 1 and further comprising:
a tool pivotally connected nearingly adjacent the first end of the survival rod.

5. The survival rod system of claim 4 and further comprising:
a nub located nearingly adjacent the first end of the survival rod;
wherein the tool includes a slot for receiving the nub for releasably securing the tool in place.

6. The survival rod system of claim 4 wherein the tool is selected from the group consisting of pick axe tool and anchor.

7. The survival rod system of claim 1 and further comprising:
a pointed end piece threadably attached to the second end of the survival rod.

8. The survival rod system of claim 1 and further comprising:
a rail system mounted to at least one of the rod sections.

9. The survival rod system of claim 8 wherein each rod section has a rail system thereby running the entire length of the survival rod.

10. The survival rod system of claim 1 and further comprising:
a paddle releasably securable to the second end of the survival rod.

11. The survival rod system of claim 1 and further comprising:
a spear releasably securable to the second end of the survival rod.

12. The survival rod system of claim 1 and further comprising:
a carrying case sized and shaped for carrying the survival rod.

13. The survival rod system of claim 1 and further comprising:
a rope eyelet formed on the second end of the survival rod.

14. The survival rod system of claim 1 wherein each rod section is capable of holding at least one of the following implements: a water filter, a flashlight, a blanket, two to three days' worth of food rations, flares, a probe rod, a mini cross bow, an Allen wrench, a blow gun and darts, and/or fishing and hunting supplies.

15. A method for surviving in the event of an emergency, the method comprising:
providing a plurality of interconnecting hollow tubular rod sections;
connecting the tubular rod sections;
creating an elongated, survival rod having a first end and a second end; and
storing one or more implements within the tubular rod sections.

16. A survival rod system for surviving in the event of an emergency, the survival rod system comprising:
a plurality of interconnecting tubular rod sections, each rod section has threaded male end and a correspondingly threaded female end, the male end of a rod section being releasably, threadably securable to the female end of an adjacent rod section, the connected rod sections creating an elongated, survival rod having a first end and a second end;
a tool pivotally connected nearingly adjacent the first end of the survival rod; and
a pointed end piece threadably attached to the second end of the survival rod;
wherein each rod section has a hollowed interior sized, shaped, and adapted for storing one or more implements within each of the rod sections.

17. The survival rod system of claim 16 and further comprising:
a nub located nearingly adjacent the first end of the survival rod;
wherein the tool includes a slot for receiving the nub for releasably securing the tool in place.

18. The survival rod system of claim 16 and further comprising:
a rail system mounted to at least one of the rod sections.

19. The survival rod system of claim 16 and further comprising:
a paddle or a spear releasably securable to the second end of the survival rod.

20. The survival rod system of claim 16 wherein each rod section is capable of holding at least one of the following implements: a water filter, a flashlight, a blanket, two to three days' worth of food rations, flares, a probe rod, a mini cross bow, an Allen wrench, a blow gun and darts, and/or fishing and hunting supplies.
